(19) United States
(12) Patent Application Publication
(10) Pub. No.: US 2004/0195099 A1
(43) Pub. Date: Oct. 7, 2004

(54) Sample filtration, concentration and separation on microfluidic devices

(76) Inventors: Stephen C. Jacobson, Knoxville, TN (US); J. Michael Ramsey, Knoxville, TN (US)

Correspondence Address: DANN, DORFMAN, HERRELL & SKILLMAN, saet, 1601 MARKET STREET, PHILADELPHIA, PA, 19103-2307, US

(21) Appl. No.: 10/407,560

(22) Filed: Apr. 4, 2003

(51) Int. Cl. G01N 27/453; B01D 61/42

(52) U.S. Cl. 204/450; 210/656; 204/600

(57) ABSTRACT

Disclosed are microfluidic devices and methods for performing analyses which, in a preferred embodiment, involve sample filtration, solid phase extraction for enrichment of target analytes and separation of target analytes via open channel electrochromatography. Small sample volumes of mixed analytes are resolvable in less than one minute using the disclosed devices and methods.

### GOVERNMENT RIGHTS STATEMENT

This invention was made with Government support under Contract No. DE-AC05-00OR22725 awarded to UT-Battelle, LLC, by the U.S. Department of Energy. The Government has certain rights in this invention.

### FIELD OF THE INVENTION

The present invention relates to the fields of microfluidics and microinstrumentation and, more particularly, to methods for filtering, concentrating and separating mixed analytes present in small sample volumes in an interconnecting microchannel structure of a microfluidic device. The methods of the invention are useful for conducting a wide range of chemical analyses, such as environmental analysis, medical testing and cell assays.

### BACKGROUND OF THE INVENTION

This specification includes citations to certain patent and literature references, which are provided to indicate the state of the art to which this invention pertains. Full citations for the literature references (designated L#) are listed at the end of the specification. The entire disclosure of each of the cited patent and literature references is incorporated by reference herein.

Interest in microfabricated devices for chemical sensing and analysis has grown substantially over the past decade, primarily because these microchips have the potential to provide information rapidly and reliably at low cost. The ease with which small sample volumes can be manipulated and the ability to fabricate microscale structures with interconnecting channels that have essentially no dead volume contribute to the high performance of these “lab-on-a-chip” devices. See, for example, U.S. Pat. Nos. 5,858,195 and 6,001,229, which are commonly owned with this application.

Many of the more recent advances in the fields of microfluidics and micro-instrumentation relate to microchips with broad ranges of functionality and versatility in the areas of chemical analysis (L1-L3). Primarily these areas have included separation methods such as electrophoresis (L4-L7), electrochromatography (L8, L9), micellar electrokinetic chromatography (L10), isotachophoresis (L11), isoelectric focusing (L12), and capillary gel electrophoresis (L13-L16). In addition, the versatile nature of these devices with regard to design possibilities and flow control by electrokinetic and/or pressure driven means offers opportunities to perform multiple functions on a single microchip. In particular sample pretreatment procedures such as concentration enhancement and filtering can be important elements integrated on lab-on-a-chip devices.

Sample concentration is useful in instances where trace analysis is desired, and the detection sensitivity is too low to reliably detect and quantify analytes. Solid phase extraction is commonly used in liquid chromatographic methods for trace analysis in aqueous samples (L17-L20) and has been used for the determination of polycyclic aromatic hydrocarbons in aqueous samples (L21-L26). On microchips, solid phase extraction has been demonstrated by coating the channel walls with a C18 phase (L27) and packing a channel with C18 coated 1.5-4 μm particles (L28). Other concentration techniques on microdevices include polymerase chain reaction (PCR) (L29-L34) and electrokinetic concentration at a porous membrane (L35) for the enhancement of DNA and other types of polymeric-samples. Electric fields and various buffer systems have been used to effect sample stacking (L36, L37), which relies on a step-wise change in the electric field, allowing charged analytes to concentrate at a discontinuity, as well as isotachophoresis (L11) on microchips. For filtration, parallel slits have been used to capture red blood cells (L38), a two dimensional array of posts to trap particulates (L39), and diffusion-based transport to separate particles and molecules (L40, L41).

Despite the above-mentioned advances, a need exists for further developments in the area of microchip separation techniques combined with sample filtration and concentration, which will enable effective analysis of neutral or charged analyte species in the microchip format, such as priority pollutants, insecticides and various other substances that are potentially harmful to humankind and the environment.

### SUMMARY OF THE INVENTION

The present invention provides devices and methods for performing analysis of test samples on a microchip format, involving sample filtration, and/or concentration, with separation of sample components of interest.

According to one aspect of the present invention, there is provided a microfluidic device for separating component species of interest present in a test sample which comprises multiple component species in a carrier medium, and which may contain particulate matter. The device of the invention has an interconnected microchannel structure including means for separating the component species of interest and at least one of (i) an inlet passage for introduction of said test sample, the inlet passage being effective to filter out the particulate matter present in said test sample, and (ii) a stationary phase material which is disposed in at least a portion of the microchannel structure and which is effective for selectively extracting the component species of interest from the test sample.

According to another aspect of this invention, there is provided a method for concentrating and separating component species of interest present in a test sample as described above. The method comprises providing a microfluidic device as described herein in which at least a portion of the microchannel structure includes a material which is effective to interact with component species of interest; transporting the test sample into contact with the stationary phase material disposed in the microchannel structure, thereby extracting the component species of interest from the carrier medium into the stationary phase material; eluting the component species of interest from the stationary phase material; and separating the component species of interest.

According to yet another aspect of this invention, there is provided a method for filtering and separating component species of interest present in a test sample as described above. The method comprises providing a microfluidic device as described herein having an interconnected microchannel structure, at least a portion of which includes a filter element, passing the test sample through the filter element, thereby filtering out particulate matter from the test sample, and separating the component species of interest.

The microfluidic devices and methods of the present invention embody a unique design that integrates the operations of particle filtration and/or solid phase extraction with chemical separations. Significant advantages accrue from integrating such processes in fabricated microfluidic systems. These advantages include automation, precise fluid control with near zero dead volume, and low cost manufacturing.

### BRIEF DESCRIPTION OF THE DRAWINGS

The various features and advantages of the present invention will be apparent to those skilled in the art from the detailed description provided below, when considered in conjunction with the accompanying drawings in which:

FIG. 1 is a schematic illustration of a microfluidic device adapted for carrying out a preferred embodiment of the present invention;

FIG. 1a is a plan view of the device;

FIG. 1b is an enlarged fragmentary view of the filter element of the device, which is bounded by the dotted line, rectangle in FIG. 1a;

FIG. 1c is a schematic illustration of a modified configuration of the channels of the filter element of the microfluidic device with a portion broken away. This configuration enables the combination of the filtration and solid phase extraction functions performed by separate elements of the device illustrated in FIGS. 1a and 1b;

FIG. 1d shows an enlarged fragmentary view of a filter element similar to that of FIG. 1b but having three channels. Also, electrodes have been added to the microfluidic device and are connected to a voltage source (V);

FIG. 1e is a fragmentary, sectional view of the inlet portion of a filter element channel structure showing graduated dimensions, providing a multi-step filter element. Depending on the fabrication method, the channel can be fabricated such that the width and/or depth of the channel can be shaped as in FIG. 1e;

FIG. 2 shows graphical representations of the results of an experiment in which pyrene solutions were concentrated with increasing loading times using the microfluidic device of FIG. 1 and subsequently eluted under isocratic conditions;

FIG. 2a shows overlaid chromatograms of varying injection times for a 2.8 μM pyrene solution;

FIG. 2b shows the variation of peak height and peak area normalized to the highest peak height and largest peak area, respectively, for pyrene solutions of varying concentrations as a function of injection time;

FIG. 3 shows chromatograms of 900 nM pyrene injections using the microfluidic device of FIG. 1;

FIG. 3a (inset) is the chromatogram for a 1 sec. injection and elution with high organic conditions (56% acetonitrile) without concentration;

FIG. 3b is the chromatogram obtained under 320 sec. concentration conditions and elution;

FIG. 4 shows the chromatograms obtained from a mixture of four different polyaromatic hydrocarbons (PAHs), at two concentration ranges, using the microfluidic device of FIG. 1;

FIG. 4a is the chromatogram for a PAH mixture composed of (1) Anthracene—2.8 μM; (2) Pyrene—0.9 μM; (3) 1,2 Benzofluorene—5.8 μM; (4) Benzo(a)pyrene—5.0 μM;

FIG. 4b is the chromatogram for a PAH mixture composed of (1) Anthracene—100 nM; (2) Pyrene—28 nM; (3) 1,2 Benzofluorene—230 nM; (4) Benzo(a)pyrene—200 nM;

FIG. 5 is a composite photograph (20× magnification) of the filter element of the microfluidic device having the design shown in FIG. 1;

FIG. 6 shows chromatograms obtained from a mixture of four PAHs under isocratic (FIG. 6a) step gradient (FIG. 6b) and linear gradient (FIG. 6c) elution conditions, using a modified form of the microfluidic device of FIG. 1. The dashed line indicates the gradient profile;

FIG. 7 shows chromatograms obtained from a mixture of four PAHs under step gradient elution conditions at varying injection times of 80 sec. (FIG. 7a), 160 sec. (FIG. 7b), and 320 sec. (FIG. 7c), also using the aforementioned modified form of the microfluidic device of FIG. 1;

FIG. 8 is a graphical representation of the effect of increasing concentration time on peak variance, based on the chromatograms of FIG. 7; ◯=anthracene; □=pyrene; ▴=1,2-benzofluorene; ▾=benzo(a)pyrene; and

FIGS. 9a-d show schematically how a series of functional elements can be configured in accordance with this invention for performing various operations, including sample input, filtration, filter flushing with buffer, concentration, transport of concentration buffer, injection, separation, transport of separation buffer and detection.

### DETAILED DESCRIPTION OF THE INVENTION

The method of the present invention accomplishes filtration and/or concentration with separation of mixed analytes rapidly and reliably in a microchip format. The terms “concentration” and “extraction” as used herein, refer to any process that promotes enrichment (increases) in the concentration of target analytes in a test sample relative to any other non-target material present in the sample. In other words, the concentrations of the analytes undergoing analysis are increased relative to the sample matrix. Non-target material and sample matrix can include the solvent, in which case the absolute concentrations of the target analytes would necessarily increase.

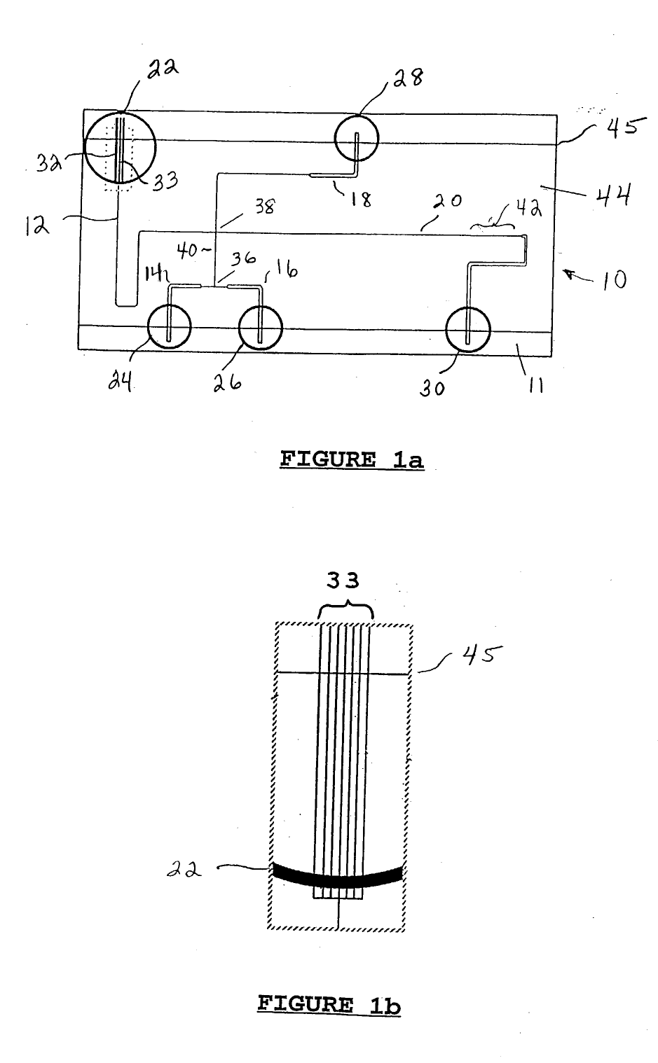

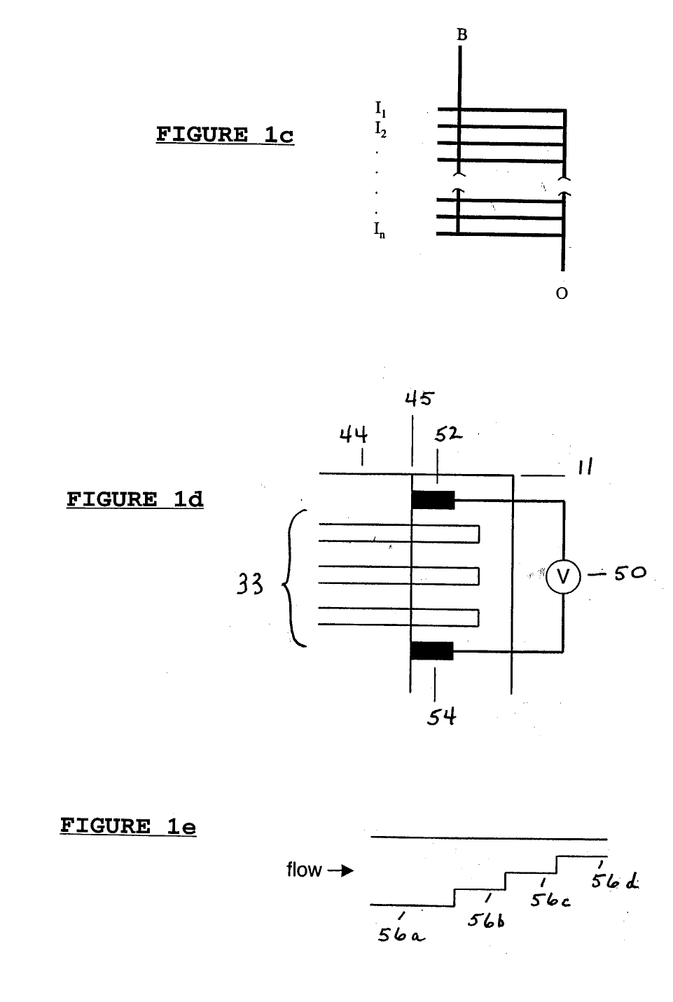

Shown in FIG. 1 is a schematic of a microchip device 10 having an interconnected microchannel structure configured to implement the methods of the present invention. The device 10 includes an integrated channel system comprising channel segments 12, 14, 16, 18, 20 and 40 which are microfabricated into a substrate or body member 11, and closed with a cover plate 44. The terminus of each channel is in fluid communication with a reservoir, which is bonded to the surface of the device. In performing the method of the invention, reservoir 22 contains the fluid sample undergoing analysis and reservoirs 24 and 26 contain first and second buffer solutions, respectively. Reservoir 28 is for sample waste and reservoir 30 is for analysis waste.

A cap or closure may be placed over the open end of the reservoirs to avoid changes in concentration due to evaporation. A cap with a septum is preferred, as it facilitates penetration by a conductive wire lead for connecting the microchip device to a suitable voltage source.

Channel segments 12, 18, 20 and 40 converge at cross-channel intersection 38, which functions as a valve element controlling the transport of sample fluid to analysis channel 20. Channel segment 40 connects the cross-channel intersection 38 with the area of confluence of material flow in channel segments 14 and 16, forming a mixing tee at which the contents of reservoirs 24 and 26 are mixed.

The microchip device is fabricated to include a filter element 32, which at once facilitates sample input and prevents passage of contaminant particles or debris, which may be present in the test sample, into the channel system. In the embodiment shown in FIG. 1b, the filter element is the form of an inlet passage having seven parallel channels 33, upon which the sample reservoir 12 is mounted. The lengthwise extent of filter element channels 33 is approximately coextensive with the diameter of sample reservoir 22. Test sample enters the filter element 32 through the portions of channels 33 disposed between the cover plate edge 45 and the edge of substrate 11. As exemplified below, the channels 33 of the filter element are fabricated so as to be of a shallower depth and/or narrower width dimension relative to the other channels in the microfluidic system.

FIG. 1c shows an alternative embodiment of a microchannel structure that combines the above-mentioned extraction and concentration functions. As can be seen in FIG. 1c, the inlet passage is composed of a plurality of input channels, Iₗ to Iₙ, which serve to introduce sample into the microfluidic system. The plurality of input channels are coated or filled with a stationary phase for extraction of hydrophobic, hydrophilic, or charged materials from the sample solution. Sample is caused to flow from the input to the output channel, O, which, in turn, is connected with a microfluidic channel network that will perform an analysis, such as electrophoresis or chromatography. After a time period determined by the partition coefficients of the target analytes and dimensions of the input channels or by operational objectives, an extraction buffer is transported from the buffer channel, B, to the output channel, O. The buffer channel B is in fluid communication with a buffer reservoir (not shown). The extraction buffer will provide sufficient solvent strength to extract and concentrate analytes from the stationary phase into the mobile extraction buffer. The sample inlet passage shown in FIG. 1c provides some advantages over the implementations shown in FIGS. 1a and 1b, such as combining filtration and solid phase extraction operations, providing greater extracted sample volume for subsequent analysis, and separating the extraction operation from the chemical separation process. The downstream injection process requires synchronization with the extraction process, so that the injection operation properly addresses the extracted sample.

The microchannel structure shown in FIG. 1c can also be used to collect particles, so that the collected particles function as the stationary phase material for concentration of the component species of interest. After the particles are collected by the filter element, the appropriate buffer is washed over the collected particles to extract test sample components of interest that are absorbed to the particles. The concentrated test sample components can be injected directly onto the separation channel or can be exposed to yet another stationary phase for further concentration.

FIG. 1d shows the sample inlet passage of a microfluidic system which is configured to allow a potential 50 to be applied between the two electrodes 52, 54 to induce electrokinetic flow. This flow can be used to clear accumulated particles or debris from the entrance to the filter element channels 33. The embodiment shown in FIG. 1d functions to generate electroosmotic flow between electrodes 52 and 54. This flow is effective to wash accumulated particles/debris from the entrance of the channels. Also, if the particles/debris are charged, the electric field will cause the particles to electrophoretically migrate from the channel entrance.

Another method to flush accumulated particles from the filter element, such as the one depicted in FIGS. 1a, b, c and d is to reverse the fluid flow out of the filter element into the sample reservoir. This flow reversal using electrokinetic or pressure driven means would push accumulated particles from the inlet passage channels.

As shown in FIG. 1e, the inlet passage can be fabricated with a series of steps in order to provide different levels of filtration on the same device. In the embodiment of FIG. 1e, the channel has four levels, 56a, 56b, 56c and 56d, with level 56a being larger than levels 56b, 56c and 56d for filtering relatively large particles, and level 56d being smaller than levels 56a, 56b and 56c for filtering relatively small particles. This multi-step filter structure is not limited to four levels as shown in FIG. 1e, as a fewer or greater number of levels can be fabricated, if desired. Also, the steps in the channel can be uniform as depicted in FIG. 1e, or varied in dimension depending on the particles to be filtered. A linear or nonlinear change in channel dimension can be used instead of the illustrated step function to achieve filtering.

The microchip device described above can be fabricated using techniques described in the literature (L42) See also U.S. Pat. Nos. 5,858,195 and 6,001,229. Suitable substrate materials include, without limitation, glass, fused silica, quartz, structural polymers such as poly(dimethylsiloxane), polymethylmethacrylate, polyolefins and the like. The channels are formed on glass or glass-like substrates surface by means of photolithographic patterning and wet chemical etching, as exemplified below. Typical channel dimensions are in the range of 10-200 microns wide by 0.1-30 microns deep. Representative channel lengths for the microchip described herein are provided below. The cover plate is bonded over the substrate containing the channel features using standard bonding techniques such as fusion bonding (L43) or cold bonding (L42). Reservoirs are affixed to the microchip using conventional adhesives such as chemical-resistant, heat-curable epoxies.

For the filter elements described in FIG. 1, a variety of fabrication techniques exist for producing channels and pores to accomplish filtering. Channels in the filter element can be shallow or narrow, or filled with or constructed from porous material depending on the fabrication technique. Also, porous materials or films can be micro/nanofabricated directly on the substrate or cover plate to effect filtering. At least one dimension of the channel or pore should be smaller than the particles being filtered. In addition, the structures shown in FIG. 1 have multiple channels for filtering. Multiple channels are preferred for redundancy in case one or more channels become clogged with accumulated particles. However, a single channel or single large aspect ratio channel or slit is capable of producing similar filtering results.

Platinum wire leads can be inserted into the reservoir, e.g. through the septum, as previously noted, for electrical contact with the solutions contained therein. Alternatively, electrical contact can be established using other electrically conductive material contacting the solutions contained in the reservoirs, such as by applying an electrically conductive metal film contact to the internal surface of the reservoirs. Similarly, pressure sources can be affixed to some or all of the reservoirs to effect fluid transport and permit operation similar to the electrokinetic transport.

Portions of the channels of the microchip device are chemically modified or filled with a solid support or stationary phase to enable concentration and, if desired, chromatographic retention, of target analytes. The stationary phase material used to modify a channel surface, e.g. by coating, or to fill a channel portion, must interact with the target analytes, so as to become bound thereto with differing degrees of avidity. The stationary phase material can be standard chromatographic stationary phases, such as normal, reverse, ion exchange, and affinity phases, or the material can be tailored for a given application. Preferred reverse phase materials for providing the stationary phase are C₄-C₁₈ derivatized silanizing agents. Representative examples of such silanizing agents include butyltrimethoxysilane, octyltrimethoxysilance and octadecyltrimethoxysilane. A coating solution in a compatible vehicle is filled into selected reservoirs and drawn through the channel system by the application of suction to ensure coating of the appropriate channel portion(s).

The eluent or mobile phase used for chromatographic, electrokinetic separation of target analytes is one which is known in the art to be effective for the analytes of interest. Considerable knowledge regarding the selection of appropriate eluents for this purpose has been gained from the study of capillary separations which utilize uncoated capillaries or capillaries coated or packed with the appropriate material. Alternatively, a suitable eluent for a specific analyte mixture can be empirically determined.

The elution strength of the mobile phase may be kept constant throughout the separation (isocratic elution) or varied over time (gradient elution).

Transport and control of sample fluid during both injection and isocratic or solvent-programmed runs may be accomplished by hydraulic, pneumatic, vacuum or electrokinetic means. The latter is demonstrated herein. Details concerning the determination of appropriate voltages for a typical sample injection and run sequence have previously been described (L10). Briefly, the voltages for the two reservoirs that flow material into the mixing tee to form the mobile phase are set to specific values for a defined mixing ratio, or varied over time for gradient runs. In both cases, these manipulations are done in such a way as to minimize changes to all other voltages and ensure a constant separation field strength.

In a particularly preferred embodiment of the invention, a gated injection technique is used to transport a plug of sample into analysis channel 20. Details of this technique have been previously described (L36). See also U.S. Pat. Nos. 5,858,195 and 6,001,229. Briefly, the reservoir voltages are set to induce a constant electrokinetic flow of test sample from the sample reservoir 22 toward the sample waste reservoir 28, while buffer from the buffer reservoirs 24 and/or 26 flows through the mixing tee 36 into the analysis channel 20 and then also toward the sample waste reservoir 28 to prevent target analytes from entering the analysis channel. For injection, the voltages at the buffer reservoirs 24 and 26 are set to allow analyte to flow into analysis channel 20. After the pre-determined sample injection time has elapsed, the voltages are reset to the initial running conditions.

Details are provided below regarding the power supply used to apply the appropriate voltages to the above-described microchip device for performing the method of the invention.

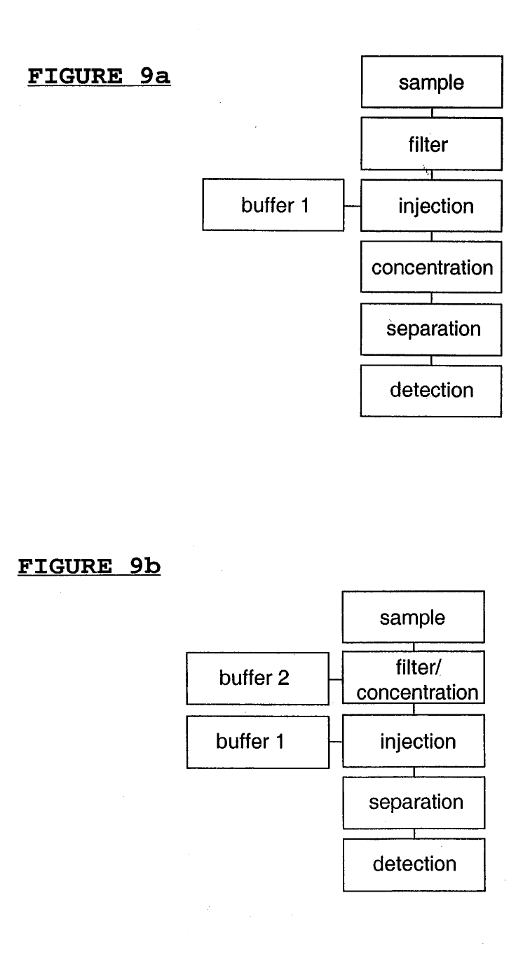

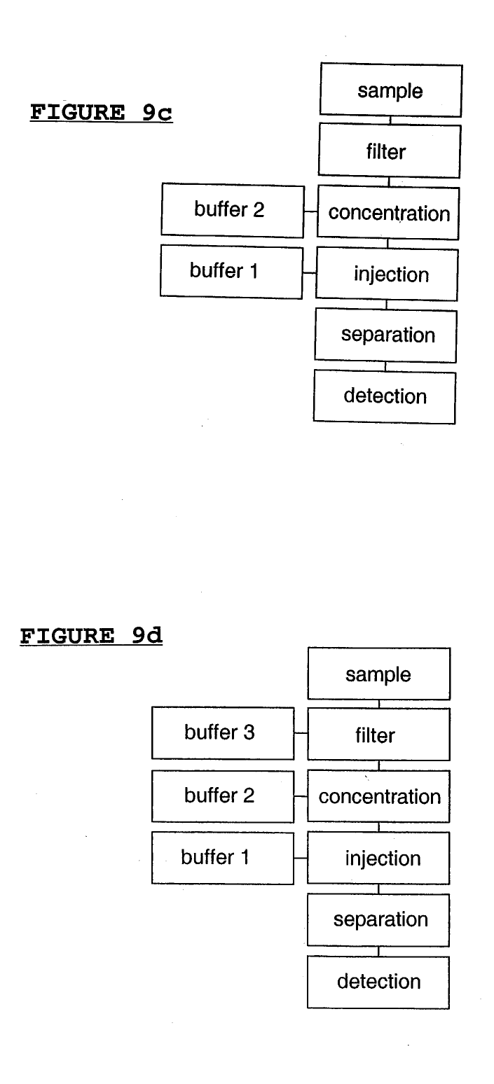

Turning to the various views of FIG. 9, FIG. 9a is a schematic representation of the functions performed by the microchip structure of FIG. 1a and is presented for illustrative purposes. The sequence of elements allows the sample to be filtered, injected, concentrated, separated, and detected. A single buffer 1 source is used to control the buffer composition for the concentration and separation elements. This buffer source can contain one or more buffer inputs that can be mixed prior to delivery to another element. For example, FIG. 1a depicts two buffers inputs joined at a mixing tee. The sequence of operations can also be rearranged as in FIG. 9b so as to permit the sample to be filtered and concentrated in the same element, injected, separated, and detected. One design for combining the filter and concentration elements is shown in FIG. 1c. The schematic of FIG. 9b contains two buffer sources, buffer 1 and buffer 2. This arrangement allows the buffer 1 source to be used to control the separation process and the buffer 2 source to be used to control the concentration process. Similar to FIG. 9a, these buffer sources can contain one or more buffer inputs. The third configuration in FIG. 9c is similar to FIG. 9b, except the filter and concentration elements are separate elements. Similar to FIG. 9b, the buffer 1 and buffer 2 sources in FIG. 9c are arranged to control the separation and concentration processes independently. In FIG. 9d, a fourth arrangement of the elements is depicted that is similar to FIG. 9c, except a buffer 3 source is added to flush accumulated particles or debris from the filter inlet. As above, the buffer 3 source can have one or more buffer inputs. The arrangement of the filter, concentration, and separation elements is not necessarily limited to the present examples. In addition, in the examples a gated injection scheme was to dispense sample. Other injection schemes including a pinched injection can be easily implemented. See, for example, U.S. Pat. Nos. 6,010,607, 6,010,608 and 6,342,142.

Detection of the component species of interest can be performed using techniques well known in the art, such as laser-induced fluorescence for detection of fluorescent molecules, amperometric measurements for electroactive species or conductivity measurements for other types of samples. The detection zone, shown at 42 in FIG. 1, is preferably located in channel 20, downstream of the analysis elements.

### EXAMPLES

The following examples describe the invention in further detail. These examples are provided for illustrative purposes only, and should not be construed as limiting the invention in any way.

### Example 1

### Microchip Fabrication

The microchips (25 mm×50 mm) were fabricated from quartz mask blanks (100 mm×100 mm) from Telic (Santa Monica, Calif.) and cover plates (17 mm×50 mm) from ESCO Products, Inc. (Oak Ridge, N.J.) or Chemglass (Vineland, N.J.) using standard photolithography, wet chemical etching and silicate bonding procedures (L42). However, the etching was carried out in two steps to produce a shallow filter element. Initially the entire channel system was etched with an ammonium fluoride/hydrofluoric acid solution (Buffered Oxide Etchant 10:1, Transene Company, Inc., Danvers, Mass.) to the desired filter channel depth, i.e., 1 μm. Photoresist was then coated over the seven channel array filter element (the portion of the element where the multiple channels merged into one channel was left uncovered). The chip with photoresist was allowed to dry at 90° C. for 30 minutes. Afterwards, the channels were etched further to the final depth, i.e., 5 μm. The chips and cover plates were treated with hydrogen peroxide (30% solution, EM Science, Gibbstown, N.J.) and ammonium hydroxide (J. T. Baker) prior to bonding with potassium silicate (KASIL 2130, The PQ Corporation, Valley Forge, Pa.). The wide channels communicating with the buffer and waste reservoirs were 206 μm wide and 5 μm deep, and the narrow channels were 22 μm wide and 5 μm deep. In a variation of the layout shown in FIG. 1, referred to herein as FIG. 1 var., the buffer channels were microfabricated with uniform narrow widths of 22 μm and depths of 5 μm. This was done in order to increase the dynamic range of mixing of material from buffer reservoir 24 and buffer reservoir 26 at tee-intersection 36.

Channel lengths for the microchips of FIG. 1 and FIG. 1 var. are listed in Table 1.

TABLE 1

| | | | Channel | | | | | | | |
|---|---|---|---|---|---|---|---|---|---|---|
| | | Chip | 14 | 16 | 12 | 18 | 20 | 40 | 32 | 32* |
| Length | Nar- | | 1.0 | 1.0 | 24.7 | 15.2 | 30 | 5.0 | 2.5 | 2.0 |
| (mm) | row | | 8.3 | 8.0 | 24.7 | 15.2 | 30 | 5.0 | 2.5 | 2.4 |
| | | var. | | | | | | | | |
| | Wide | | 9.5 | 9.3 | — | 8.4 | 15 | — | — | — |
| | | | — | — | | 8.7 | 13 | | | |
| | | var. | | | | | | | | |

*Denotes the shallow portion of the filter element.

The fluid reservoirs (4 mm or 6 mm i.d.×7 mm length) were cut from glass tubing and attached using epoxy (Epo-Tex 353ND-T, Epoxy Technology, Billerica, Mass.).

### Example 2

### Application of Stationary Phase to Microchannels

The microchips fabricated in Example 1 were cleaned, prior to coating with silanizing agent, by rinsing with water, 1 N NaOH (J. T. Baker, Phillipsburg, N.J.), water, 1 N HCl (J. T. Baker), water, and finally HR-GC grade methanol (EM Science) for at least 10 minutes each. The microchips were then dried overnight at 110° C. A 10% (w/w) solution of octadecyl-trimethoxysilane (Fluka, Buchs, Switzerland) and a 1% (v/v) solution of n-butylamine (Sigma, St. Louis, Mo.) were prepared in toluene (EM Science) that had been dried over 3 Å molecular sieve (J. T. Baker). A coating solution was then prepared by adding 20 μL of the n-butylamine solution to 2 g of the octadecyltrimethoxysilane solution. The analysis waste reservoir 30 was filled with the coating solution and dried toluene was placed in both buffer reservoirs 24, 26 and the sample reservoir 22. A subambient pressure was applied to the sample waste reservoir 28 to facilitate coating of the analysis channel 20 and sample waste channel 18 only. An uncoated sample channel 12 eliminated the need for long equilibration times before a representative sample could be injected onto the analysis channel 20. The coating time was 2 hours. The microchips thus coated were then rinsed thoroughly with toluene for at least 20 minutes and then rinsed with 100% methanol. The microchips were rinsed with methanol and stored in a methanol bath after each set of experiments.

### Example 3

### Microchip Operation and Analyte Detection

Prior to analysis the microchips fabricated in Example 1 were rinsed with a 10 mM TRIS buffer with 20% acetonitrile (v/v). The sample was placed in sample reservoir 22 with or without 5 μm silica particles (YMC, Inc, Morris Plains, N.J.). In buffer reservoir 24 and buffer reservoir 26 were placed 10 mM TRIS buffer with 20% acetonitrile and 60% acetonitrile, respectively. 10 mM TRIS buffer with 20% acetonitrile was placed in the two remaining reservoirs, and all reservoirs were capped with white rubber septa (Aldrich) to minimize evaporation. Five independent high voltage power supplies (1OA12-P4; Ultravolt, Ronkonkoma, N.Y.) provided the electrical potential for the reservoirs. Each potential source was computer controlled using multifunction I/O cards (PCI-M1016-XE50; National Instruments, Austin, Tex.) in a Power Macintosh 7500/100 running LabVIEW (National Instruments). Platinum wire electrodes were inserted through the septa to make electrical contact with the buffer solutions. The gated injection method of U.S. Pat. No. 6,001,229 (see also L43) was used to load the sample onto the analysis channel at cross-channel intersection 38. Mixing at a tee-intersection has been demonstrated and described previously (L9 and L10). In this case, the mixing range of buffer from reservoir 26 with buffer from reservoir 24 was 10%-90%, and allowed a minimum and maximum acetonitrile concentration for elution of 24% and 56%, respectively. This range of organic concentration provided the necessary selectivity for the samples tested. Prior to test sample injection the analysis channel 20 was equilibrated with 10 mM TRIS buffer with 24% (v/v) acetonitrile. All buffers were prepared from a stock TRIS buffer solution made from 99.9% TRIZMA base (Sigma, St. Louis, Mo.) dissolved in Nanopure purified water (Barnstead, Dubuque, Iowa) and adjusted to pH 8.2 with HCl (Fisher Scientific, Fairlawn, N.J.).

The computer controlled injection and elution programs in this example were set up to a) maintain equilibration conditions for 10 sec., b) inject the test sample for a preset time and c) begin the elution scheme for the remaining time. The applied potentials are listed in Table 2.

TABLE 2
Potentials Applied to Buffer 1 and 2 Reservoirs
during Microchip Operation*

| | FIG. 1 Microchip | | FIG. 1 var. Microchip | |
|---|---|---|---|---|
| | Buffer | Buffer | Buffer | Buffer |
| | Res. 24 | Res. 26 | Res. 24 | Res. 26. |
| Operating condition | (kV) | (kV) | (kV) | (kV) |
| equilibrate | 2.04 | 1.96 | 2.10 | 1.90 |
| inject | 1.14 | 1.14 | 1.12 | 1.12 |
| 24% ACN | 2.04 | 1.96 | 2.10 | 1.90 |
| 52% ACN | 1.97 | 2.03 | 1.84 | 2.16 |
| 56% ACN | 1.93 | 2.07 | 1.80 | 2.20 |

*Potentials at the sample, sample waste, and analysis waste reservoirs were held constant at 2.2, 1.0 (0.80 for FIG. 1 var. Microchip), and 0.0 kV, respectively.

Test samples were injected onto the analysis channel 20 by lowering the voltages at buffer reservoir 24 and buffer reservoir 26, and these potentials were held for the desired injection time. These voltage settings produced a field strength of 350 V/cm in analysis channel 20. The isocratic elution used 56% acetonitrile over the course of the separation. The step gradient used was maintained at 52% acetonitrile for the first 10 sec. of the elution scheme and then switched to 56% acetonitrile for the remainder of the analysis time. For the linear gradient the elution program started at 24% acetonitrile and ramped in 1% increments to 56% acetonitrile over 16 sec. A field strength of 500 V/cm along analysis channel 20 was maintained for all of the above elution processes. Due to slight variations in channel geometries the applied potentials to the FIG. 1 var. microchip differed nominally from those applied to the microchip of FIG. 1. For all voltage settings during test sample injection and analyte elution, the sample reservoir 22 maintained the highest applied voltage setting. This design allows the chip to be operated at an alternative voltage scheme with the sample reservoir 22 at ground and the remaining reservoirs set to a negative potential.

Laser-induced fluorescence (LIF) was used for sample detection. The 325 nm line of an Omnichrome Series 74 He—Cd laser (2074-M-AO2; Melles Griot, Carlsbad, Calif.) was focused using a 200 mm focal length lens on a portion of the analysis channel serving as a detection zone at a point 29 mm from the injection valve. Fluorescence emission, collected using a 40× microscope objective, was focused on an 800 μm pinhole, spectrally filtered using a 350 nm longpass filter, and then measured by a photomultiplier tube (PMT, 77348 Oriel Instruments, Inc., Stratford, Conn.). The PMT signal was fed through a Keithley 428 current amplifier (Keithley Instruments, Inc., Cleveland, Ohio) with a 10 ms filter. Data were collected at 25 Hz or 50 Hz by the same multifunction I/O card used for voltage control, and the LabVIEW program used for voltage control also served for data acquisition.

Images of regions of interest on the chip were obtained using a CCD camera (TE/CCD-512TKM; Princeton Instruments, Inc., Trenton, N.J.) on a Nikon Eclipse TE300 microscope (Nikon, Inc., Melville, N.Y.) at 20× magnification. IPLab Software (Signal Analytics Corp., Vienna, Va.) was used for image acquisition and camera operation. A high-pressure mercury arc lamp was used to excite rhodamine B (Eastman Kodak) solutions in 10 mM TRIS buffer with 20% (v/v) acetonitrile for imaging fluid flow during injections at the cross-channel intersection 38 and mixing at mixing tee 36.

### Example IV

### Sample Analysis

### a. Analyte Concentration

Samples of various concentrations in 10 mM TRIS with 20% (v/v) acetonitrile were prepared from stock solutions of the PAHs in acetonitrile (the PAHs being anthracene 98%, pyrene 99+%, 1,2 benzofluorene 99+%, (Aldrich, Milwaukee, Wis.) and benzo(a)pyrene (Eastman Kodak, Rochester, N.Y.)). Proper care in handling these compounds must be taken due to their potentially carcinogenic nature.

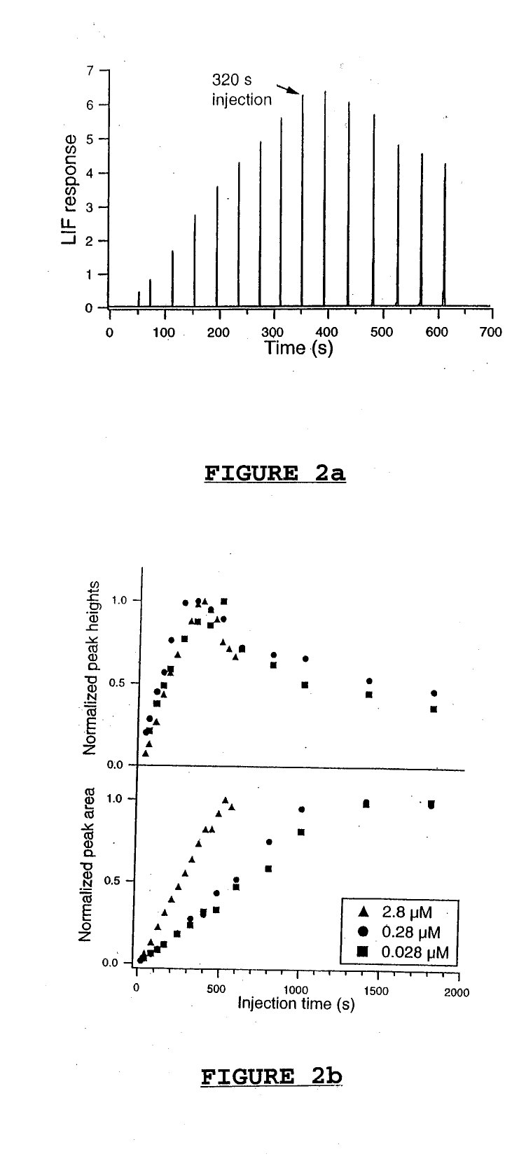

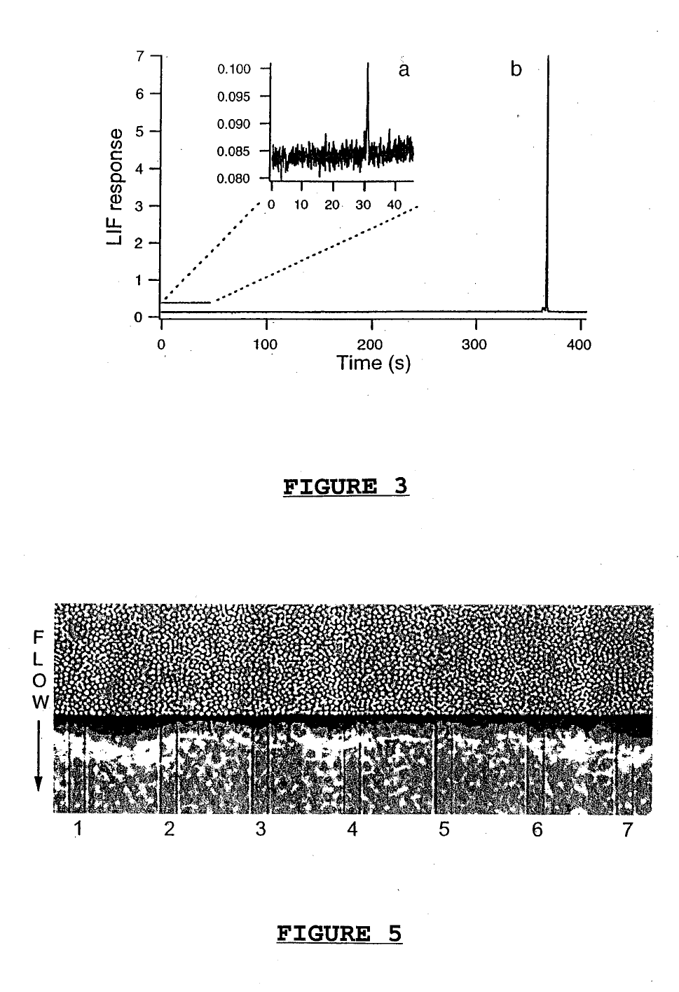

Pyrene at 0.028, 0.28, and 2.8 μM was concentrated with increasing loading times and subsequently eluted under isocratic conditions at 56% acetonitrile on the microchip of FIG. 1. The chromatograms for the 2.8 μM concentration were overlaid and are shown in FIG. 2a. FIG. 2b shows the peak heights for each concentration normalized to their respective largest peak maximum over the entire injection time range. All three concentrations showed a maximum in peak height in the 300 to 480 sec injection time range. For long injection times, e.g., greater than 360 sec for 2.8 μM, the peak heights gradually decrease with increasing injection time. The trend in peak height could be the result of some mixing in unpredicted flow behavior in buffer channels 14 and 16 during extended injection times, e.g. greater than 400 sec, but was reproducible. Despite this trend the peak areas (normalized to their maximum peak area) showed a linear increase with injection time leading to a plateau (FIG. 2b). There was a finite amount of stationary phase in analysis channel 20, and the amount of material that could be concentrated reached a maximum after which no additional sample could be accumulated on the stationary phase. The time to reach this plateau for a given compound increased with decreasing concentration as seen in FIG. 2b.

To determine the signal enhancement factor, pyrene (900 nM) was concentrated with increasing loading times up to 320 sec and compared to a standard 1 sec injection. For the 1 sec injections, the analysis channel 20 was equilibrated with 56% acetonitrile instead of 24% and eluted with 56% acetonitrile. The chromatograms for a 1 sec injection and a 320 sec concentration time are shown in FIG. 3. The 1 sec injection (FIG. 3a) barely registers as a disturbance on the same scale as the 320 sec injection (FIG. 3b), and therefore, the chromatogram of FIG. 3a was rescaled and included as an inset. For each loading time an enhancement factor was calculated by dividing the baseline corrected peak height by the average height for the 1 sec injections. The enhancement factor with loading time was linear with a correlation coefficient of 0.995, with an enhancement factor for the 320 sec injection data of 400. (The data were smoothed using a second order, 11-point, Savitzky-Golay function.)

### b. Chromatographic Separation of Analyte Mixture

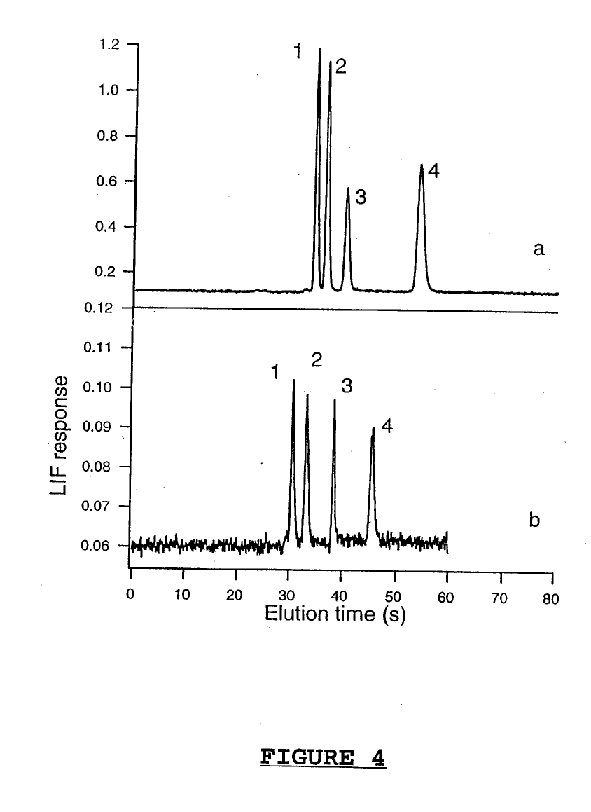

To demonstrate the feasibility of separating a concentrated sample on analysis channel 20, 20 sec injections of a four component mixture were made in two concentration ranges on the microchip of FIG. 1. These injections were made without silica particles present at the filter. The resulting chromatograms are shown in FIG. 4. The sample was comprised of anthracene (2.8 μM), pyrene (0.9 μM), 1,2 benzofluorene (5.8 μM), and benzo(a)pyrene (5.0 μM) in FIG. 4a, and anthracene (100 nM), pyrene (28 nM), 1,2 benzofluorene (230 nM), and benzo(a)pyrene (200 nM) in FIG. 4b. The step gradient used after loading was 52% acetonitrile for 10 sec, and then switching to 56% acetonitrile for the remainder of the analysis to achieve baseline resolution. Limits of detection (LOD, set at 3σ) were calculated from smoothed data for the compounds in FIG. 4b and were 3.1 nM for anthracene, 1.0 nM for pyrene, 8.1 nM for 1,2 benzofluorene, and 17 nM for benzo(a)pyrene for a 20 sec concentration time. The LOD of pyrene for this 20 sec concentration time is 48 times lower than the LOD of the 1 sec standard injection without concentration (48 nM, FIG. 3a). This value matches well with the enhancement factor of 49 calculated for the 20 sec concentration time, included in the series shown in FIG. 2a, over the 1 sec standard injection. Extrapolating using an enhancement factor of 400 for the 320 sec concentration time, an LOD of 100 pM for pyrene should be attainable.

### c. Analysis with Sample Filtration

Microchip operation was also tested with 5 μm silica particles added to the test sample reservoir to simulate a solid contaminant. These particles were effectively blocked from entering the sample channels as shown in FIG. 5. At 20× magnification the seven channels comprising the filter element could not be completely imaged and, therefore, three frames were taken to form the composite image. To test the effect of these particles on chip operation, a sample of rhodamine B prepared in buffer with 20% acetonitrile was used to image the valving operation at cross channel intersection 38. Valve operation was observed to be unaffected by the presence of the particles.

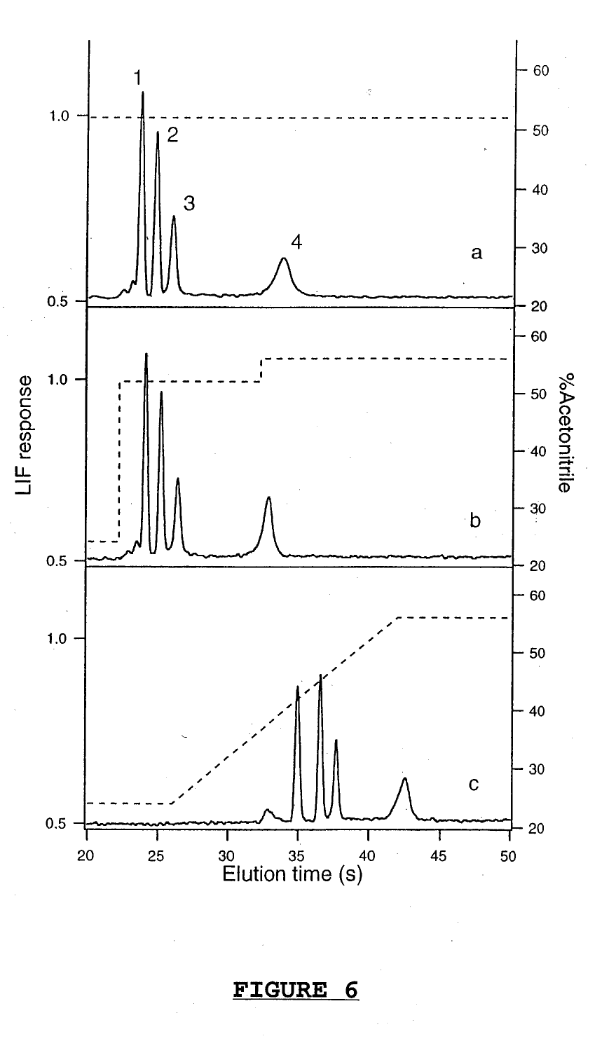

The separation of the four PAHs with 5 μm silica present as the simulated solid contaminant was repeated on the FIG. 1 var. microchip, having uniformly narrow channels, using three elution schemes to assess the effect of the particles on peak resolution. The components and their concentrations in the sample were 2.8 μM anthracene, 0.90 μM pyrene, 5.8 μM 1,2 benzofluorene, and 5.0 μM benzo(a)pyrene in buffer with 20% acetonitrile. The resulting chromatograms are shown in FIG. 6. Isocratic elution at 52% acetonitrile provided good resolution of all four compounds (FIG. 6a). A step gradient beginning at 52% acetonitrile, holding for 10 sec, and ramping to 56% acetonitrile gave similar resolution (FIG. 6b). However, the step gradient sharpened the peak for the last eluting compound, benzo(a)pyrene, compared to the isocratic elution in FIG. 6a. The linear gradient, shown in FIG. 6c improved separation between the first and second compound, worsened the peak shape of the last eluting compound, increased the overall analysis time by about 10 sec, but provided an increased peak capacity (see below). The linear gradient was not optimized for the sample tested here. Efficiency values, N, for the peaks in FIG. 6a, were calculated from their 2^{nd} moment. These values and the plate heights, H, are shown in Table 3.

TABLE 3

| | Efficiency, | Plate height, |
|---|---|---|
| Peak | N | H (μm) |
| 1- Anthracene | 31800 | 0.912 |
| 2- Pyrene | 31600 | 0.918 |
| 3- 1,2 Benzofluorene | 25100 | 1.16 |
| 4- Benzo(a)pyrene | 3320 | 8.74 |

In addition, peak capacities were determined for FIGS. 6a, b, and c and were 26, 30, and 45, respectively, for a resolution, R, of 1.0. The peak capacity for FIG. 6b (with particles at the filter) compares favorably to the peak capacities of 37 and 31 (without particles) calculated for FIGS. 4a and b, respectively. Isocratic and step gradient elution were, in this case, more than capable of providing acceptable results and in less time.

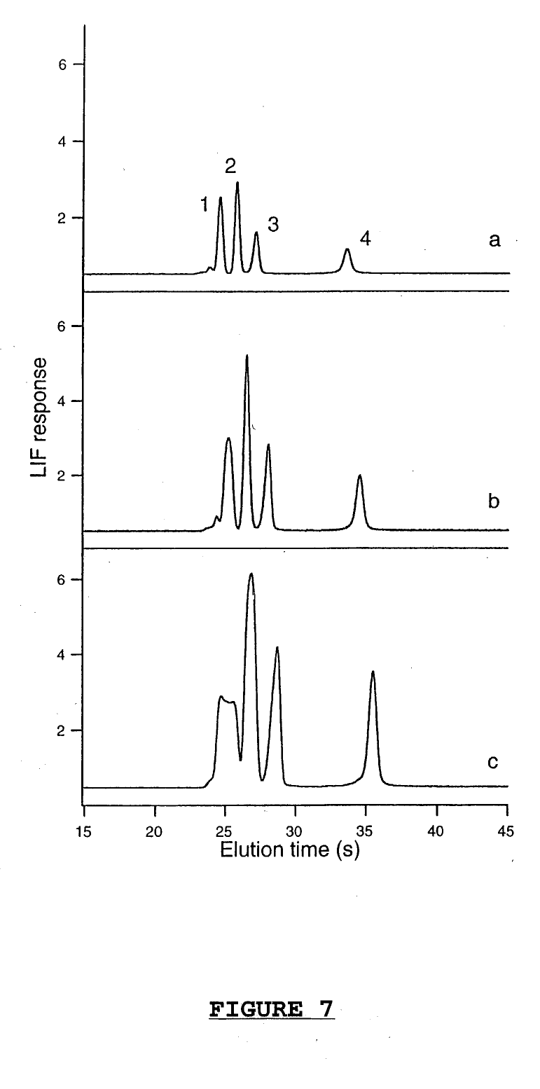

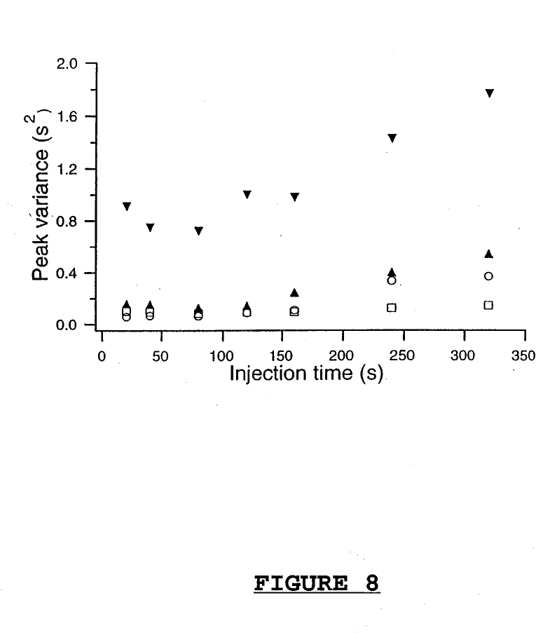

Using the step gradient elution method the effect of concentration time on the separation was evaluated. FIGS. 7a, b, and c show the chromatograms for an 80, 160, and 320 sec injection, respectively, while filtering 5 μm silica at the sample reservoir, as shown in FIG. 5. With increasing concentration time an increase in both peak height and width was observed for the first sample peak, anthracene. The peak shapes of anthracene and pyrene show some degree of deformation as the injection time approached and/or surpassed their respective breakthrough times (210 sec for anthracene and 400 sec for pyrene). The peak variance for increasing concentration time is presented in FIG. 8. The peak variances were calculated assuming a Gaussian distribution for all sample peaks except for the first eluting peak (anthracene) concentrated for 160 sec and 320 sec where a rectangular distribution was assumed. Where necessary the peak width was extrapolated to baseline. As expected the peak variances hold steady and then begin to increase as more sample was concentrated with increasing injection time. Maximum concentration without additional dispersion for all four compounds was located at the 80 sec concentration time.

From the foregoing test results, it will be appreciated that preconcentration and separation of a four component mixture can be successfully performed on a microchip device. Furthermore, filtration of solid particles from the test sample is achievable without a detrimental impact on chip operation and performance. Reasonable efficiencies for isocratic elution runs were obtained despite having a relatively short analysis channel and limited stationary phase density. Longer separation channels can be fabricated on these microfluidic devices, if necessary or desirable. Also, use of monolithic or packed phases in the channels will increase the stationary phase density for concentration and/or separation.

### LITERATURE REFERENCES

1. Colyer, C. L.; Tang, T.; Chiem, N.; Harrison, D. J. Electrophoresis 1997, 18, 1733-1741.

2. Effenhauser, C. S.; Bruin, G. J. M.; Paulus, A. Electrophoresis 1997, 18, 2203-2213.

3. Ramsey, J. M. Nature Biotech. 1999, 17, 1061-1062.

4. Manz, A.; Harrison, D. J.; Verpoortei E. M. J.; Fettinger, J. C.; Paulus, A.; L di, H.; Widmer, H. M. J. Chromatogr. 1992, 593, 253-258.

5. Harrison, D. J.; Fluri, K.; Seiler, K.; Fan, Z.; Effenhauser, C. S.; Manz, A. Science 1993, 261, 895-897.

6. Effenhauser, C. S.; Manz, A.; Widmer, H. M. AnaL Chem. 1993, 65, 2637-42.

7. Jacobson, S. C.; Hergenröder, R.; Koutny, L. B.; Ramsey, J. M. AnaL Chem. 1994, 66, 1114-1118.

8. He, B.; Tait, N.; Regnier, F. AnaL Chem. 1998, 70, 3790-3797.

9. Kutter, J. P.; Jacobson, S. C.; Matsubara, N.; Ramsey, J. M. AnaL Chem. 1998, 70, 3291-3297.

10. Kutter, J. P.; Jacobson, S. C.; Ramsey, J. M. AnaL Chem. 1997, 69, 5165-517 1.

11. Walker, P. A., 111; Morris, M. D.; Bums, M. A.; Johnson, B. N. Anal. Chem. 1998 70, 3766-3769.

12. Hofmann, O.; Che, D.; Cruickshank, K. A.; M Iler, U. R. Anal. Chem. 1999, 71, 678-686.

13. Woolley, A. T.; Mathies, R. A. Proc. Natl. Acad. Sci. U.S. A. 1994, 91, 11348-11352.

14. Effenhauser, C. S.; Paulus, A.; Manz, A.; Widmer, H. M. Anal. Chem. 1994, 66, 2949-2953.

15. Schmalzing, D.; Adourian, A.; Koutny, L.; Ziaugra, L.; Matsudaira, P.; Ehrlich, D. Anal. Chem. 1998, 70, 2303-23 10.

16. Waters, L. C.; Jacobson, S. C.; Kroutchinina, N.; Khandurina, J.; Foote, R. S.; Ramsey, J. M. Anal. Chem. 1998, 70, 5172-5176.

17. Berrueta, L. A.; B. Gallo; Vicente, F. Chromatographia 1995, 40, 474-481.

18. Font, G.; Ma es, J.; Molt, J. C.; Pic, Y. J Chromatogr. 1993, 642, 135-161.

19. Hennion, M. C. J Chromatogr. A 1999, 856, 3-54.

20. Subra, P.; Hennion, M. C.; Rosset, R.; Frei, R. W. J Chromatogr. A 1988, 456, 121-141.

21. Bouzige, M.; Pichon, V.; Hennion, M. C. J Chromatogr. A 1998, 823, 197-210.

22. Furton, K. G.; Jolly, E.; Pentzke, G. J Chromatogr. 1993, 642, 33-45.

23. Kicinski, H. G.; Adamek, S.; Kettrup, A. Chromatographia 1989, 28, 203-208.

24. Kiss, G.; Varga-Puchony, Z.; Hlavay, J. J Chromatogr. A 1996, 725, 261-272.

25. Nirmaier, H. P.; Fischer, E.; Meyer, A.; Henze, G. J Chromatogr. A 1996, 730, 169-175.

26. Vera-Avila, L. E.; Covarrubias, R. Intern. J Environ. Anal. Chem. 1994, 56, 33-47.

27. Kutter, J. P.; Jacobson, S. C.; Ramsey, J. M. J Microcolumn September 2000, 12, 93-97.

28. Oleschuk, R. D.; Shultz-Lockyear, L. L.; Ning, Y.; Harrison, D. J. Anal. Chem. 2000, 72, 585-590.

29. Ibrahim, M. S.; Lofts, R. S.; Jahrling, P. B.; Henchal, E. A.; Weedn, V. W.; Northrup, M. A.; Belgrader, P. Anal. Chem. 1998, 70, 2013-2017.

30. Kopp, M. U.; Mello, A. J. d.; Manz, A. Science 1998, 280, 1046-1048.

31. Northrup, M. A.; Benett, B.; Hadley, D.; Landre, P.; Lehew, S.; Richards, J.; Stratton, P. Anal. Chem. 1998, 70, 918-922.

32. Ross, P. L.; Davis, P. A.; Belgrader, P. Anal. Chem. 1998, 70, 2067-2073.

33. Waters, L. C.; Jacobson, S. C.; Kroutchinina, N.; Khandurina, J.; Foote, R. S.; Ramsey, J. M. Anal. Chem. 1998, 70, 158-162.

34. Lagally, E. T.; Medintz, I.; Mathies, R. A. Anal. Chem. 2001, 73, 565-570.

35. Khandurina, J.; Jacobson, S. C.; Waters, L. C.; Foote, R. S.; Ramsey, J. M. Anal. Chem. 1999, 71, 1815-1819.

36. Jacobson, S. C.; Ramsey, J. M. Electrophoresis 1995, 16, 481-486.

37. Kutter, J. P.; Ramsey, R. S,; Jacobson, S. C.; Ramsey, J. M. J Microcolumn September 1998, 10, 313-319.

38. Wilding, P.; Pfahler, J.; Bau, H. H.; Zemel, J. N.; Kricka, L. J. Clin. Chem. 1994, 40, 43-47.

39. He, B.; Tan, L.; Regnier, F. Anal. Chem. 1999, 71, 1464-1468.

40. Brody, J. P.; Yager, P. Sensors and Actuators A 1997, 58, 13-18.

41. Weigl, B. H.; Yager, P. Science 1999, 283, 346-347.

42. Khandurina, J.; Jacobson, S. C.; Waters, L. C.; Foote, R. S.; Ramsey, J. M. Anal. Chem. 1999, 71, 1815-1819.

43. Jacobson, S. C.; Koutny, L. B.; Hergenröder, R.; Moore, A. W., Jr.; Ramsey, J. M. Anal. Chem. 1994, 66, 3472-3476.

44. Landers, J. P. In Handbook of Capillary Electrophoresis; CRC Press: New York, 1997, pp 894.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departing from the scope of the appended claims.

What is claimed is:

1. A method for concentrating and separating component species of interest present in a test sample which comprises multiple component species in a carrier medium, and which may also contain particulate matter, said method comprising:
a. providing a microfluidic device having an interconnected microchannel structure, at least a portion of said microchannel structure including a material which is effective to interact with said component species;
b. transporting said test sample into contact with said stationary phase material whereby said component species is extracted from said carrier medium into said stationary phase material,
c. eluting said component species of interest from said stationary phase material; and
d. separating said component species of interest.

2. The method of claim 1, wherein said microfluidic device includes a filter element and said method further comprises the step of filtering said test sample.

3. The method of claim 1, wherein said transporting step is performed under the influence of electrokinetic force, a pressure driven force, or combination thereof.

4. The method of claim 1, wherein said eluting step is performed under the influence of electrokinetic force, pressure driven force, or combination thereof.

5. The method of claim 1, wherein said separating step is performed under the influence of electrokinetic force, pressure driven force, or combination thereof.

6. The method of claim 1, wherein said transporting step, said eluting step, and said separating step are performed under the influence of electrokinetic force, pressure driven force, or combination thereof.

7. The method of claim 1, wherein said separating step is an electrophoretic separation.

8. The method of claim 1, wherein said separating step is a chromatographic separation.

9. The method of claim 8, wherein said separating step is conducted using said stationary phase material.

10. The method of claim 8, wherein said separating step is a reverse phase chromatographic separation.

11. The method of claim 1, wherein said separating step is performed under isocratic elution conditions.

12. The method of claim 1, wherein said separating step is performed under gradient elution conditions.

13. The method of claim 12, wherein said separating step is performed under step gradient elution conditions.

14. The method of claim 12, wherein said separating step is performed under linear gradient elution conditions.

15. The method of claim 12, wherein said separating step is performed under non-linear gradient elution conditions.

16. The method of claim 1 further comprising the step of detecting at least one of the component species of interest.

17. The method of claim 1, wherein the interconnected microchannel structure of said microfluidic device comprises at least first, second, third, and fourth channel segments, each channel segment having first and second ends with said second ends forming a channel intersection, and at least first, second, third and fourth materials contained in said channel segments, respectively, said first material containing said test sample, and a stationary phase material disposed in at least a portion of one of said channel segments, and the step of contacting the first material with the stationary phase material comprises applying a motive force to said channel segments, which is effective to transport said first material into contact with said stationary phase material.

18. The method of claim 17, wherein said stationary phase material is disposed in at least a portion of said third channel and said method further comprises the preliminary step of applying a motive force to said channel segments, which is effective to transport said first material into said second channel segment, and to transport said fourth material into said third channel segment.

19. The method of claim 18, wherein the motive force applied in said preliminary step is reapplied to said channel segments to transport said first material into said second channel segment and to transport said fourth material into said third channel segment to elute said first material from said stationary phase material.

20. The method of claim 17, wherein said applied motive force is an electrokinetic force, a pressure driven force, or a combination of said forces.

21. The method of claim 17, wherein said microchannel structure further includes a fifth channel segment containing a fifth material and forming a junction between said first and second ends of said fourth channel segment, and said method further comprises the step of applying a motive force to said fifth channel to mix said fourth and fifth materials at said junction.

22. The method of claim 21, wherein the motive force applied to said fifth channel is an electrokinetic force, a pressure driven force, or a combination of said forces.

23. The method of claim 17, wherein said microchannel structure further includes an inlet passage in fluid communication with the first end of said first channel segment, and said applied motive force is effective to cause said first material to traverse said inlet passage, thereby filtering out particulate matter present in said first material passing through said inlet passage in the direction of said first channel.

24. The method of claim 23, wherein at least a portion of said inlet passage has at least one dimension smaller than said particulate matter to effect filtering of said test sample.

25. The method of claim 23, wherein at least a portion of said inlet passage has a material disposed therein, said material having at least one dimension smaller than said particulate matter to effect filtering of said test sample.

26. The method of claim 23, wherein said inlet passage comprises a plurality of microchannels.

27. The method of claim 17 further comprising the step of detecting at least one of the component species of interest.

28. The method of claim 27, wherein said third channel segment includes a detection zone, and the detecting step comprises detecting at least one of the separated component species of interest as said at least one separated component species of interest is transported into said detection zone.

29. The method of claim 17, wherein the motive force applied for material transport is under computer control.

30. The method of claim 2, wherein said microfluidic device is provided with at least a portion of said microchannel structure filled with said stationary phase material.

31. The method of claim 30, wherein said portion of microchannel structure comprises said filter element.

32. The method of claim 2, wherein said stationary phase material is coated onto at least a portion of said microchannel structure.

33. The method of claim 32, wherein said portion of microchannel structure comprises said filter element.

34. The method of claim 23 further comprising the step of removing from said inlet passage particulate matter filtered by said inlet passage.

35. The method of claim 34, wherein said particulate matter is removed under the influence of electrokinetic force induced by imposing a potential difference laterally across said inlet passage.

36. The method of 34, wherein said particulate matter is removed by altering the applied motive force so as to reverse the direction of flow of said first material.

37. A method for filtering and separating component species of interest present in a test sample which comprises multiple component species in a carrier medium, and which may also contain particulate matter, said method comprising:
a. providing a microfluidic device having an interconnected microchannel structure, at least a portion of said microchannel structure including a filter element;
b. transporting said test sample through said filter element, thereby filtering out particulate matter from said test sample; and separating said component species of interest.

38. The method of claim 37, wherein at least a portion of said microchannel structure includes a stationary phase material which is effective to selectively extract said component species of interest from said test sample, and said method further comprises the step of eluting said component species of interest from said stationary phase material.

39. A microfluidic device for separating component species of interest present in a test sample which comprises multiple component species in a carrier medium, and which may contain particulate matter, said device having an interconnected microchannel structure including means for separating said component species of interest and at least one of:
a. an inlet passage for introduction of said test sample, said inlet passage being effective to filter out the particulate matter present in said test sample; and
b. a stationary phase material disposed in at least a portion of said microchannel structure said stationary phase material being effective to selectively extract said component species of interest from said test sample.

40. A device of claim 39, wherein at least a portion of said inlet passage has at least one dimension smaller than said particulate matter to effect filtering of said test sample.

41. A device of claim 39, wherein at least a portion of said inlet passage has a material disposed therein, said material having at least one dimension smaller than said particulate matter to effect filtering of said test sample.

42. The device of claim 39, including both a. and b.

43. The device of claim 39, wherein said stationary phase is disposed in said inlet passage.

44. The device of claim 42, wherein said stationary phase is disposed in said inlet passage.
